(19) United States
(12) Patent Application Publication
(10) Pub. No.: US 2020/0361351 A1
(43) Pub. Date: Nov. 19, 2020

(54) VEHICLE SEAT

(71) Applicant: TOYOTA BOSHOKU KABUSHIKI KAISHA, Aichi-ken (JP)

(72) Inventors: Tatsuya OKUBO, Aichi-ken (JP); Fumitoshi AKAIKE, Aichi-ken (JP)

(73) Assignee: TOYOTA BOSHOKU KABUSHIKI KAISHA, Aichi-ken (JP)

(21) Appl. No.: 16/869,242

(22) Filed: May 7, 2020

(30) Foreign Application Priority Data
May 13, 2019 (JP) 2019-090375

(51) Int. Cl. B60N 2/56; B60N 2/00

(52) U.S. Cl. CPC B60N 2/5678; B60N 2/64; B60N 2/002

(57) ABSTRACT

A vehicle seat including: a seat body on which an occupant is capable of sitting, the seat body including a seat heater including a heater wire, wherein the heater wire of the seat heater constitutes a bent member having a predetermined shape, the bent member being obtained by bending the heater wire, and wherein the bent member is pulled and the predetermined shape of the bent member is deformed as pressure applied to a seat surface of the seat body increases, so that a density of the heater wire per unit area of the seat surface decreases.

### TECHNICAL FIELD

The present disclosure relates to a vehicle seat including a seat body on which an occupant sits. The seat body includes a seat heater.

### BACKGROUND

JP-A-2004-175291 describes a seat heater provided on a sitting surface of a vehicle seat. As shown in FIG. 11, the seat heater includes heaters 102a to 102f provided in a filmy sheet 100. The filmy sheet 100 is provided with seat sensors 104a, 104b that detect an occupant seated in the vehicle seat. This makes it possible to supply power to the heaters 102a to 102f when the seat sensors 104a, 104b detect the occupant seated in the vehicle seat.

In general, the occupant is more likely to feel heat in a part where sitting pressure is high such as a buttock portion and is less likely to feel heat in a part where the sitting pressure is low. For this reason, the occupant feels that an amount of heat varies depending on parts of the sitting surface even when constant power is supplied to the heaters 102a to 102f. The amount of heat of the heaters 102a to 102f in the above-described seat heater cannot be adjusted according to sitting pressure.

### SUMMARY

The present disclosure provides a seat heater capable of adjusting an amount of heat in accordance with sitting pressure.

According to an aspect of the present disclosure, there is provided a vehicle seat including: a seat body on which an occupant is capable of sitting, the seat body including a seat heater including a heater wire, wherein the heater wire of the seat heater constitutes a bent member having a predetermined shape, the bent member being obtained by bending the heater wire, and wherein the bent member is pulled and the predetermined shape of the bent member is deformed as pressure applied to a seat surface of the seat body increases, so that a density of the heater wire per unit area of the seat surface decreases. Here, the seat surface of the seat body corresponds to a sitting surface in a seat cushion and a backrest surface in a seat back.

Accordingly, the bent member configured by the heater wire is pulled and the predetermined shape of the bent member is deformed as pressure (sitting pressure) applied to the seat surface of the seat body increases, so that the density of the heater wire per unit area of the seat surface decreases. Therefore, even when power supplied to the heater wire is constant, it is possible to reduce an amount of heat in a part where pressure applied to the seat surface is high. Accordingly, the occupant feels approximately uniform heat from each part of the seat surface.

### BRIEF DESCRIPTION OF DRAWINGS

FIG. 1 is an overall perspective view of a car seat according to a first embodiment of the present disclosure as viewed from a left front side;

FIG. 2 is a plan view showing a relationship between a seat heater and a cushion pad of a seat cushion of the car seat;

FIG. 3 is a longitudinal cross-sectional view (cross-sectional view taken along a line III-III in FIG. 1) of the seat cushion;

FIG. 4 is a schematic plan view of the seat heater;

FIG. 5 is a longitudinal cross-sectional view showing a coil of the seat heater in a state in which no sitting pressure is applied to a sitting surface of the seat cushion;

FIG. 6 is a longitudinal cross-sectional view showing the coil of the seat heater in a state in which an occupant is seated on the sitting surface of the seat cushion;

FIG. 7 is a longitudinal cross-sectional view showing the coil of the seat heater in the state in which the occupant is seated on the sitting surface of the seat cushion;

FIG. 8 is a schematic plan view showing a density of a heater wire per unit area of the seat surface when the coil is stretched;

FIG. 9 is a schematic view showing a modified example of the coil;

FIG. 10 is a schematic view showing a modified example of the seat heater; and

FIG. 11 is a plan view showing a seat heater and the like of a vehicle seat in related art.

### DETAILED DESCRIPTION

### First Embodiment

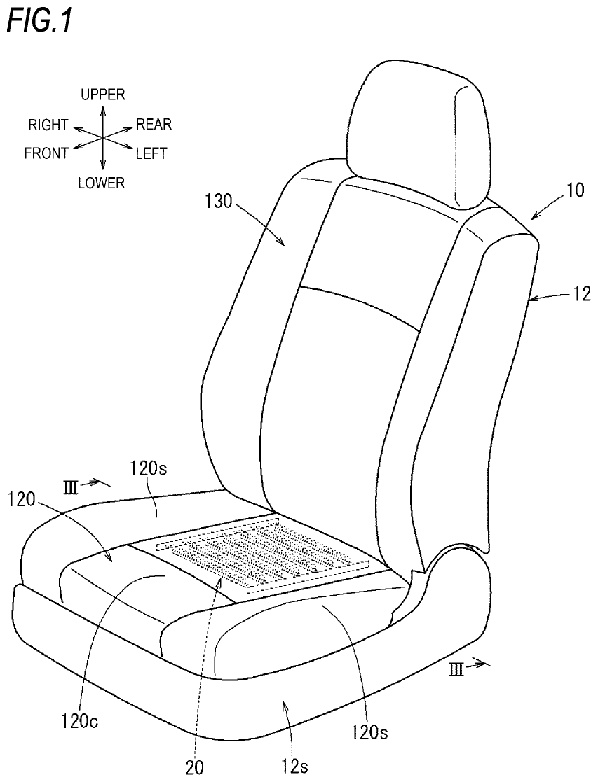

Hereinafter, a vehicle seat according to the first embodiment of the present disclosure will be described with reference to FIGS. 1 to 10. The vehicle seat according to the present embodiment is a car seat including a seat heater. Front, rear, left, right, upper, and lower sides shown in the drawings correspond to front, rear, left, right, upper, and lower sides of a car including the car seat according to the present embodiment.

<Overview of Car Seat 10>

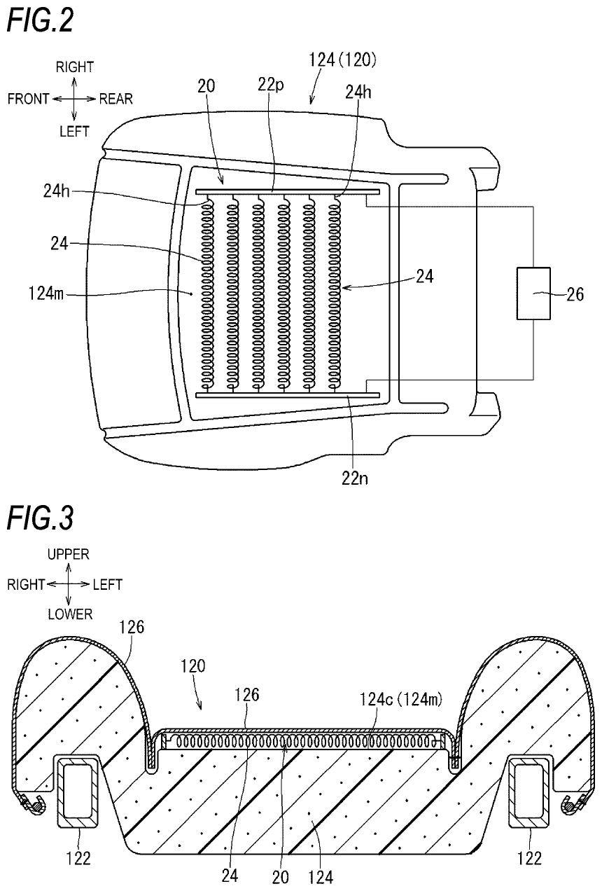

As shown in FIGS. 1 and 2, the car seat 10 includes a seat body 12 on which an occupant M is capable of sitting and a seat moving device (not shown) that slides the seat body 12 in a front-rear direction and lifts the seat body 12 up and down in a vehicle interior. The seat body 12 includes a seat cushion 120 and a seat back 130. As shown in FIG. 1, a frame-shaped shield 12s that covers the seat moving device is provided on a lower side of the seat cushion 120.

As shown in FIG. 1, the seat cushion 120 includes a central portion 120c in a width direction and left and right side portions 120s. A surface of the central portion 120c in the width direction is a sitting surface.

As shown in FIG. 3, the seat cushion 120 includes a cushion pad 124 formed of urethane or the like that covers a cushion frame 122 from an upper side. A surface (sitting surface) 124m of the cushion pad 124 is provided with a seat heater 20, as is shown in FIGS. 2 and 3. The surface of the cushion pad 124 is covered with a cover 126.

<Seat Heater 20>

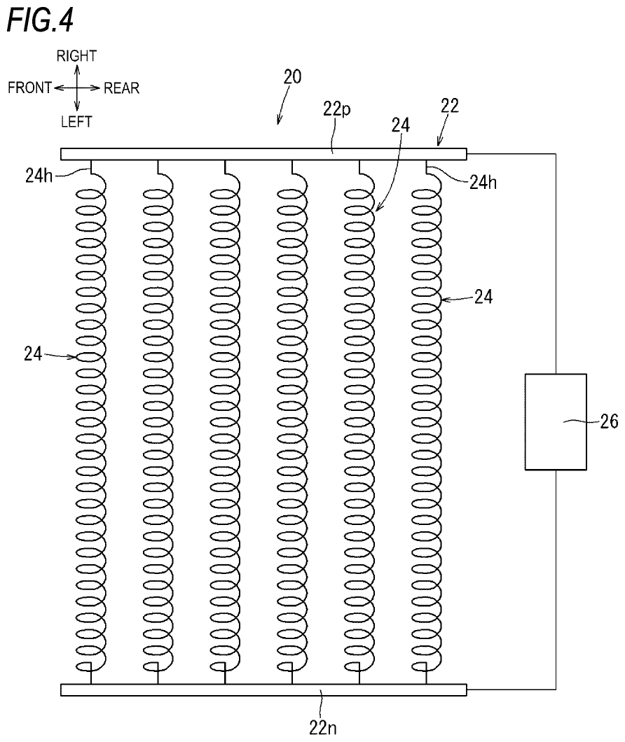

As shown in FIG. 4, the seat heater 20 includes a power supply wire 22, a plurality of coils 24, and a power supply device 26. The power supply wire 22 includes a plus wire 22p provided on a right side of the seat cushion 120 (cushion pad 124) and a ground wire 22n provided on a left side of the seat cushion 120. The coils 24 are constituted by heater wires 24h and have a constant number of turns per unit length. One ends of the coils 24 are connected to the plus wire 22p of the power supply wire 22 and the other ends of the coils 24 are connected to the ground wire 22n of the power supply wire 22.

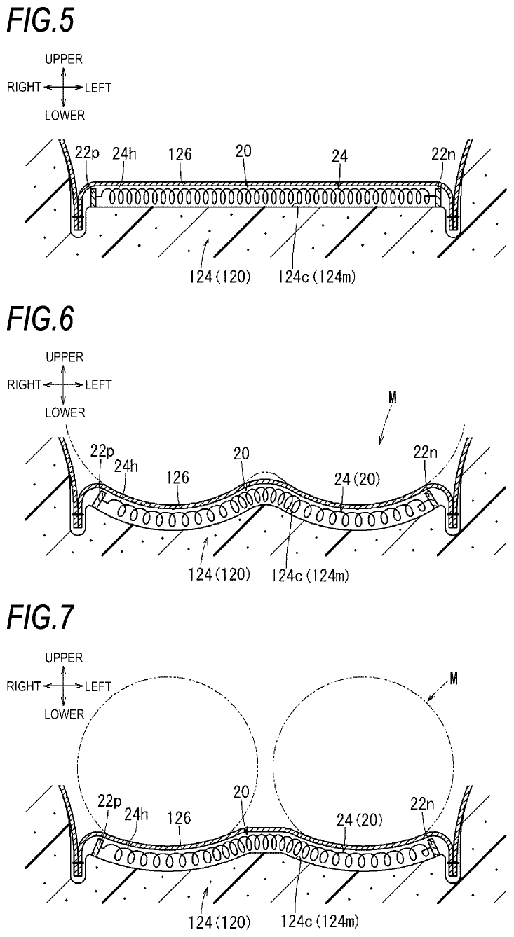

A plurality of (six in the drawing) coils 24 are provided at intervals in a front-rear direction of the cushion pad 124 and extend in a left-right direction to traverse the sitting surface 124m of the cushion pad 124. That is, the plurality of coils 24 are connected to the power supply wire 22 in parallel. As shown in FIGS. 3 and 5, the plurality of coils 24 and the power supply wire 22 are accommodated in accommodation grooves 124c formed on the sitting surface 124m of the cushion pad 124. In this state, the surface of the cushion pad 124 is covered with the cover 126.

With the above configuration, when the occupant M is seated on the seat cushion 120 of the seat body 12 as shown in FIGS. 6 and 7, the sitting surface 124m of the cushion pad 124 deforms to a lower side due to pressure (sitting pressure) applied to the sitting surface of the seat cushion 120. FIG. 6 shows an example of deformation of the sitting surface 124m by buttocks of the occupant M. FIG. 7 shows an example of deformation of the sitting surface 124m by thighs of the occupant M. In this manner, when the sitting surface 124m of the cushion pad 124 deforms, the coils 24 of the seat heater 20 are pulled to be stretched in axial directions thereof.

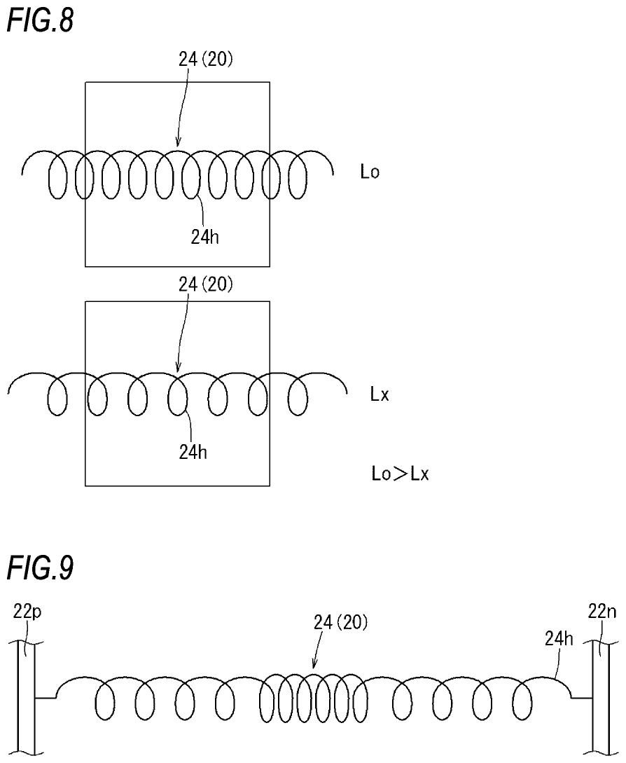

As a result, as shown in FIG. 8, a density of the heater wires 24h per unit area (see the square frame) of the sitting surface of the seat cushion 120 is low (sparse (see the lower view in FIG. 8)) in a part where sitting pressure is high and is high (dense (see the upper view in FIG. 8)) in a part where the sitting pressure is low. Further, an inductance L of the coils 24 changes depending on a case where the occupant M is not seated and a case where the occupant M is seated. That is, when the occupant M is seated, the number of turns per unit length of the coils 24 decreases since the coils 24 are stretched in the axial directions thereof. Accordingly, an inductance Lx of the coils 24 when the occupant M is seated is smaller than an inductance L0 of the coils 24 when the occupant M is not seated (Lx<L0).

As shown in FIG. 4, the power supply device 26 of the seat heater 20 supplies power to the coils 24 connected in parallel through the power supply wire 22. A control unit (not shown) of the power supply device 26 detects the occupant M seated on the sitting surface of the seat cushion 120 according to a change in the inductance L of the coils 24. Here, an impedance Zc of the coils 24 of the seat heater 20 is expressed by Rc (coil resistance)+jωL (coil inductance). An impedance Zm of the power supply wire 22 of the seat heater 20 is expressed by Rm (resistance of power supply wire)+jωLm (inductance of power supply wire (=approximately zero)).

In an electric circuit, fluctuations in noise or the like are reflected at a connecting part of members having different impedances. Therefore, in a case of the seat heater 20, fluctuations in noise or the like are reflected at connecting parts between the coils 24 and the power supply wire 22. Here, a magnitude of a reflected wave e (hereinafter referred to as noise intensity e) is expressed by e=K (constant)×Zc/Zm.

Zc: impedance of the coils 24; Zm: impedance of the power supply wire 22

Therefore, by detecting the magnitude of the noise intensity e by the control unit of the power supply device 26, the change in the inductance L of the coils 24 due to the occupant M being seated on the sitting surface of the seat cushion 120 can be grasped. The control unit of the power supply device 26 supplies power to the seat heater 20 when the occupant M is seated on the sitting surface of the seat cushion 120. That is, the coils 24 of the seat heater 20 can be used as a seat sensor.

<Operation of Seat Heater 20>

In a state in which the occupant M is not seated on the seat cushion 120 of the seat body 12 (see FIG. 5), the coils 24 of the seat heater 20 are not stretched and the inductance L of the coils 24 is L0 which is relatively large. For this reason, the noise intensity (e=K Zc/Zm) also has a relatively large value. Next, when the occupant M is seated on the seat cushion 120 (see FIG. 6 and the like), the coils 24 of the seat heater 20 are stretched and the inductance L of the coils 24 decreases (L=Lx). For this reason, the noise intensity (e=K×Zc/Zm) also has a relatively small value. The control unit of the power supply device 26 detects the occupant M seated on the seat cushion 120 according to the change in the noise intensity e.

When the seated occupant M is detected, the control unit of the power supply device 26 supplies power to the seat heater 20. Here, since the coils 24 are stretched in the axial directions thereof in a state in which the occupant M is seated, the density of the heater wires 24h per unit area (see the square frame) of the sitting surface of the seat cushion 120 is low (sparse) in the part where the sitting pressure is high and is relatively high (dense) in the part where the sitting pressure is low, as is shown in FIG. 8. For this reason, even when constant power is supplied from the power supply device 26 to the seat heater 20, an amount of heat is relatively small in the part where the sitting pressure is high and is relatively high in the part where the sitting pressure is low. In general, the occupant M is more likely to feel heat in the part where the sitting pressure is high. Accordingly, the occupant M uniformly feels the amount of heat of the seat heater 20.

### Correspondence Between Terms of Car Seat 10 According to First Embodiment and Terms According to Present Disclosure

The coils 24 constituted by the heater wires 24h correspond to the bent member of the present disclosure. The coils 24 being stretched in the axial direction due to sitting pressure corresponds the predetermined shape of the bent member being deformed of the present disclosure. The coils 24 correspond to a sensor that detects the occupant of the present disclosure.

### Advantages of Car Seat 10 According to Present Embodiment

According to the car seat 10 in the present embodiment, the coils 24 (bent member) formed by the heater wires 24h are stretched in the axial direction thereof as the sitting pressure increases so that the density of the heater wires 24h per unit area of the sitting surface of the seat cushion 120 decreases. Therefore, even when power supplied to the heater wires 24h is constant, it is possible to reduce the amount of heat in the part where the sitting pressure is high relative to the amount of heat in the part where the sitting pressure is low. Accordingly, the occupant M uniformly feels heat of the seat heater 20. Further, it is not necessary to provide a seat sensor separately from the seat heater 20 since the seat heater 20 can be used as a seat sensor, which is economical.

### Modified Examples

Here, the present disclosure is not limited to the above-described embodiment and modifications can be made without departing from the scope of the present disclosure. For example, as shown in FIG. 4, the present embodiment describes an example in which the coils 24 constituted by the heater wires 24h have a constant number of turns per unit length. However, in the coils 24 constituted by the heater wires 24h as shown in FIG. 9, the number of turns may be small in a part where the amount of heat is desired to be reduced and be large in a part where it is not necessary to reduce the amount of heat. Accordingly, a heat balance of the seat heater 20 can be adjusted on a part basis.

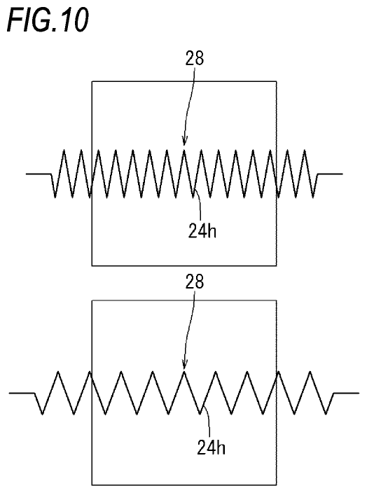

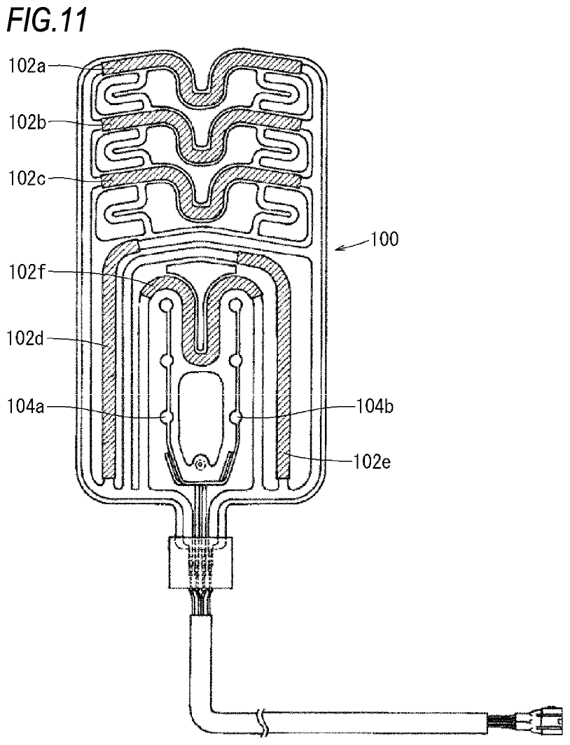

In the present embodiment, the coils 24 are constituted by the heater wires 24h. However, as shown in FIG. 10, the heater wires 24h may also be bent into a bellows shape to form a bent member 28. Accordingly, it is possible to obtain a part where the heater wires 24h are sparse and a part where the heater wires 24h are dense in accordance with the sitting pressure, as is in a case of the coils 24. Further, the accommodation grooves 124c of the sitting surface 124m of the cushion pad 124 may be omitted since a thickness of the bent member 28 can be made smaller than that of the coils 24. The bent member 28 can also be attached to a back surface of the cover 126 of the seat cushion 120.

Although the seat heater 20 is provided to the seat cushion 120 in the present embodiment, the seat heater 20 may also be provided to the seat back 130. Although the present disclosure is applied to the car seat 10 in the present embodiment, the present disclosure can also be applied to a seat of a train, an airplane, or a ship other than a car.

The present disclosure provides illustrative, non-limiting examples as follows:

According to a first aspect of the present disclosure, there is provided a vehicle seat including: a seat body on which an occupant is capable of sitting, the seat body including a seat heater including a heater wire, wherein the heater wire of the seat heater constitutes a bent member having a predetermined shape, the bent member being obtained by bending the heater wire, and wherein the bent member is pulled and the predetermined shape of the bent member is deformed as pressure applied to a seat surface of the seat body increases, so that a density of the heater wire per unit area of the seat surface decreases. Here, the seat surface of the seat body corresponds to a sitting surface in a seat cushion and a backrest surface in a seat back.

According to the first aspect, the bent member configured by the heater wire is pulled and the predetermined shape of the bent member is deformed as pressure (sitting pressure) applied to the seat surface of the seat body increases, so that the density of the heater wire per unit area of the seat surface decreases. Therefore, even when power supplied to the heater wire is constant, it is possible to reduce an amount of heat in a part where pressure applied to the seat surface is high. Accordingly, the occupant feels approximately uniform heat from each part of the seat surface.

According to a second aspect of the present disclosure, there is provided the vehicle seat according to the first aspect, wherein whether the occupant is seated on the seat surface of the seat body is detected depending on whether the predetermined shape of the bent member constituted by the heater wire has deformed. That is, the bent member configured by the heater wire can be used as a seat sensor.

According to a third aspect of the present disclosure, there is provided the vehicle seat according to the second aspect, wherein the bent member constituted by the heater wire serves as both the seat heater and a sensor that detects the occupant. For this reason, it is not necessary to provide a seat sensor separately from the seat heater, which is economical.

According to a fourth aspect of the present disclosure, there is provided the vehicle seat according to any one of the first to third aspects, wherein the bent member before being deformed by the pressure applied to the seat surface includes: a first part in which the density of the heater wire per unit area of the seat surface is a first density; and a second part in which the density of the heater wire per unit area of the seat surface is a second density higher than the first density. For this reason, heat balance of the seat heater can be adjusted on a part basis.

According to a fifth aspect of the present disclosure, there is provided the vehicle seat according to any one of the first to fourth aspects, wherein the bent member is a coil constituted by the heater wire, and wherein the coil is stretched in an axial direction thereof as the pressure applied to the seat surface of the seat body increases. That is, the coil is stretched in the axial direction thereof as the sitting pressure increases so that the density of the heater wire per unit area of the seat surface decreases. Further, with the coil being stretched, an inductance L of the coil decreases. For this reason, by grasping a change in the inductance L of the coil, it is possible to detect the occupant.

According to a sixth aspect of the present disclosure, there is provided the vehicle seat according to any one of the first to fifth aspects, wherein the seat body includes a seat cushion and a seat back, and wherein the bent member constituted by the heater wire is provided between a cushion pad and a cover of the seat cushion. For this reason, the seat heater can be easily attached to the seat body.

According to the present disclosure, it is possible to provide a seat heater capable of adjusting the amount of heat in accordance with sitting pressure.

What is claimed is:

1. A vehicle seat comprising:
a seat body on which an occupant is capable of sitting, the seat body including a seat heater including a heater wire,
wherein the heater wire of the seat heater constitutes a bent member having a predetermined shape, the bent member being obtained by bending the heater wire, and
wherein the bent member is pulled and the predetermined shape of the bent member is deformed as pressure applied to a seat surface of the seat body increases, so that a density of the heater wire per unit area of the seat surface decreases.

2. The vehicle seat according to claim 1,
wherein whether the occupant is seated on the seat surface of the seat body is detected depending on whether the predetermined shape of the bent member constituted by the heater wire has deformed.

3. The vehicle seat according to claim 2,
wherein the bent member constituted by the heater wire serves as both the seat heater and a sensor that detects the occupant.

4. The vehicle seat according to claim 1,
wherein the bent member before being deformed by the pressure applied to the seat surface includes: a first part in which the density of the heater wire per unit area of the seat surface is a first density; and a second part in which the density of the heater wire per unit area of the seat surface is a second density higher than the first density.

5. The vehicle seat according to claim 1,
wherein the bent member is a coil constituted by the heater wire, and
wherein the coil is stretched in an axial direction thereof as the pressure applied to the seat surface of the seat body increases.

6. The vehicle seat according to claim 1,
wherein the seat body includes a seat cushion and a seat back, and
wherein the bent member constituted by the heater wire is provided between a cushion pad and a cover of the seat cushion.
